(19) United States
(12) Patent Application Publication
(10) Pub. No.: US 2007/0034765 A1
(43) Pub. Date: Feb. 15, 2007

(54) Adjustable suspended shelf structure

(76) Inventor: Wen-Ping Lo, Taoyuan Hsien (TW)

Correspondence Address: PRO-TECHTOR INTERNATIONAL SERVICES, 20775 NORADA CT., SARATOGA, CA, 95070, US

(21) Appl. No.: 11/199,886

(22) Filed: Aug. 9, 2005

(51) Int. Cl. B42F 13/00

(52) U.S. Cl. 248/343

(57) ABSTRACT

An adjustable suspended shelf structure includes a fixed disc, a suspending rod, an adjusting mechanism and a base; wherein the suspending rod is connected to the fixed disc and its bottom is coupled with the adjusting mechanism, and the adjusting mechanism includes a sphere and a bowl-shape tray, so that the adjusting mechanism is connected to a base having a plurality of longitudinal and transversal long holes to define a suspended shelf. The fixing disc is mounted onto the ceiling, such that an object such as an overhead projector, a lamp or a speaker can be fixed onto the base to constitute a suspending status, and the angle of the object can be adjusted quickly by rotating the sphere of the adjusting mechanism around the tray.

### BACKGROUND OF THE INVENTION

1. Field of the Invention

The present invention relates to an adjustable suspended shelf structure, and more particularly to a suspended shelf structure capable of hanging various different objects and adjusting the shelf to different angles.

2. Description of the Related Art

In general, a suspended shelf for hanging an overhead projector, a lamp or a speaker as shown in FIG. 1 comprises an upper and a lower shelves 11, 12, and the lower shelf 12 mounts an overhead projector 2 or another object, and the upper shelf 11 has a long arc hole 111, 113 disposed separately on the longitudinal and transversal sides of the upper shelf 11, and the upper shelf 11 is connected to the ceiling and suspended by a suspending rod 13. With the movements of the long arc holes 111, 113, the angle of elevation of the lower shelf 12 can be adjusted. It is not easy to align the central line of a lens of the overhead projector according to this prior art, and particularly for a fine tune of an angle that requires many times of adjustments before the installation can be completed.

### SUMMARY OF THE INVENTION

It is a primary objective of the present invention to provide an adjustable suspended shelf structure capable of adjusting the angle of the suspended shelf and improving the practicability of the suspended shelf.

The foregoing suspended shelf structure comprises a fixed disc, a suspending rod, an adjusting mechanism and a base; wherein the suspending rod is connected to the fixed disc and its bottom is coupled to the adjusting mechanism, and the adjusting mechanism is connected to a base, and the fixed disc is secured onto the ceiling, so that an object such as an overhead projector, a lamp, or a speaker can be fixed onto the base to constitute a suspending status, and the adjusting mechanism can be rotated freely to adjust the suspended shelf into different angles quickly. Such arrangement makes the adjusting operating simple, easy and convenient.

The foregoing suspended shelf structure includes a tubular base and a sphere disposed in the tubular base, and the sphere is placed on a bowl-shape tray, and the top of the sphere is connected to the suspending rod, such that the angle of the base can be adjusted by rotating the sphere along the tray.

The foregoing suspended shelf structure includes a base having a plurality of longitudinal and transversal long holes for fixing different objects.

### BRIEF DESCRIPTION OF THE DRAWINGS

FIG. 1 is a perspective view of a prior art suspended shelf;

FIG. 2 is an exploded view of a suspended shelf of the present invention;

FIG. 3 is another exploded view of a suspended shelf of the present invention;

FIG. 4 is a cross-sectional view of a suspended shelf of the present invention;

FIGS. 5 to 6 are perspective views and cross-sectional views of a suspended shelf respectively according to a preferred embodiment of the present invention; and

FIG. 7 is a perspective view of a suspended shelf according to another preferred embodiment of the present invention.

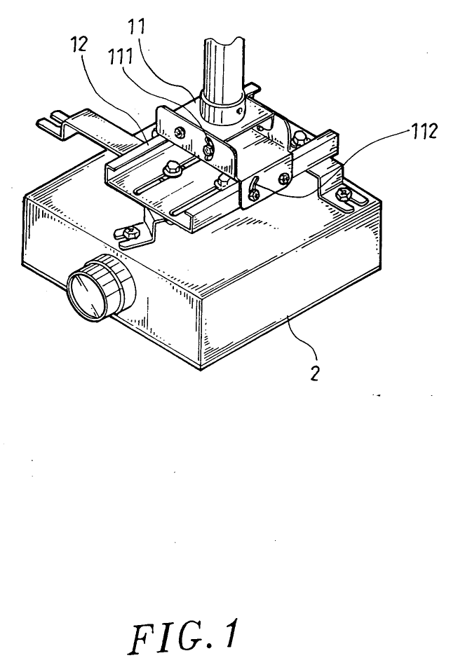

### DETAILED DESCRIPTION OF THE PREFERRED EMBODIMENTS

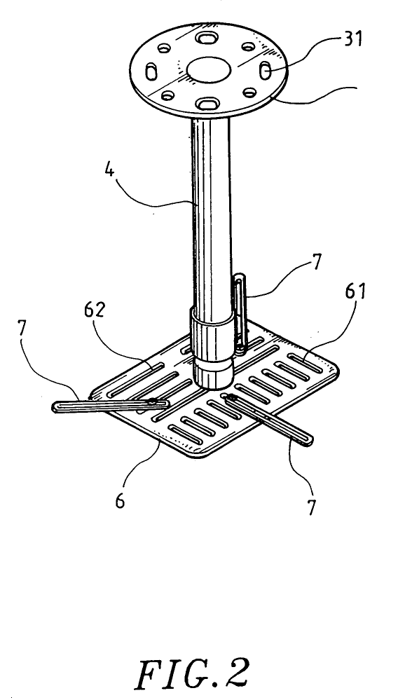

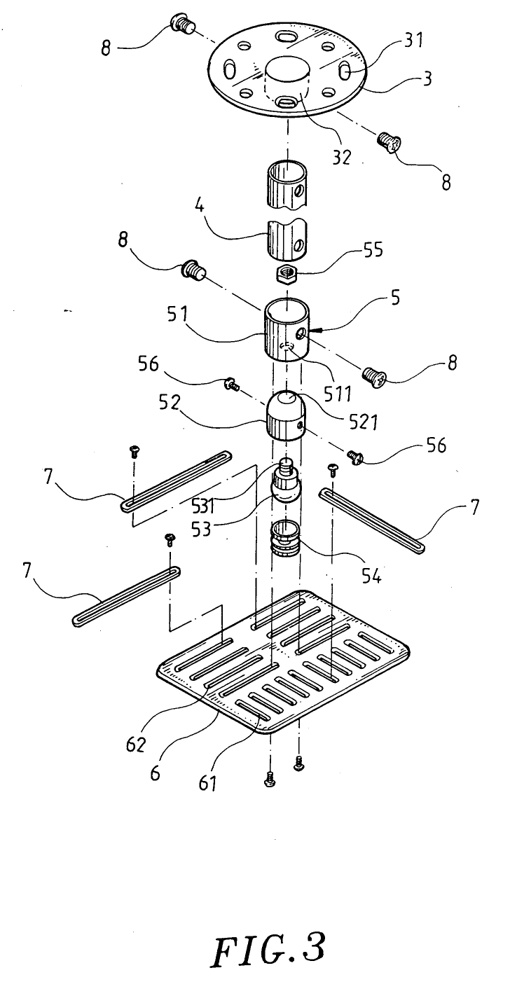

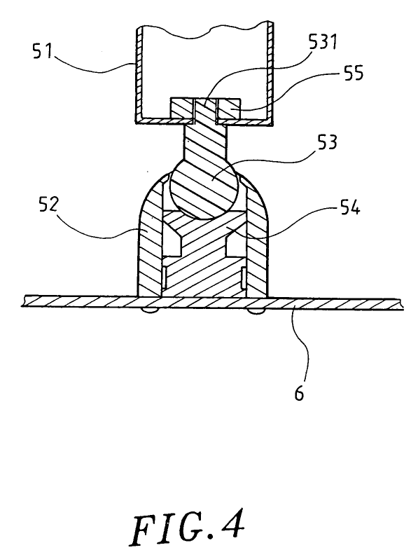

Referring to FIGS. 2 to 4, the present invention comprises a fixed disc 3, a suspending rod 4, an adjusting mechanism 5 and a base 6; wherein the fixed disc 3 includes a plurality of fixing holes 31 and a bushing 32 disposed at the center of the bottom of the fixed disc 3.

The adjusting mechanism 5 includes a bushing 51, a through hole 511 disposed at the bottom of the bushing 51, and a fixed base 52 having a penetrating hole 521 and disposed at the top, and the fixed base 52 contains a sphere 53 having a screw bolt 531 at its top, and a bowl-shape tray 54 is placed under the sphere 53, such that the screw bolt 531 of the sphere 53 is passed through the penetrating hole 521 of the fixed base 52, the bushing 51 and the through hole 511 and secured by a screw nut 55 and then fixed by a screw 56. The tray 54 is secured by both sides of the fixed base 52.

The base 6 includes a plurality of longitudinal and transversal long holes 61, 62 for securing a plurality of fixing rods 7.

With the foregoing components, the suspending rod 4 is sheathed into the bushing 51 of the fixed disc 3 and secured by the screw 8 to define a suspended shelf, so that an object such as an overhead projector, a lamp, or a speaker can be fixed onto the base 6 (since the base 6 has the longitudinal and transversal holes 61, 62, therefore objects of different sizes can be mounted onto the base 6). The fixed disc 3 is fixed onto the ceiling to constitute a suspending status, and the angle of elevation of the base 6 can be adjusted by rotating the sphere 53 of the adjusting mechanism 5 along the tray 54. Such arrangement makes the adjustment of angles simple, easy and convenient.

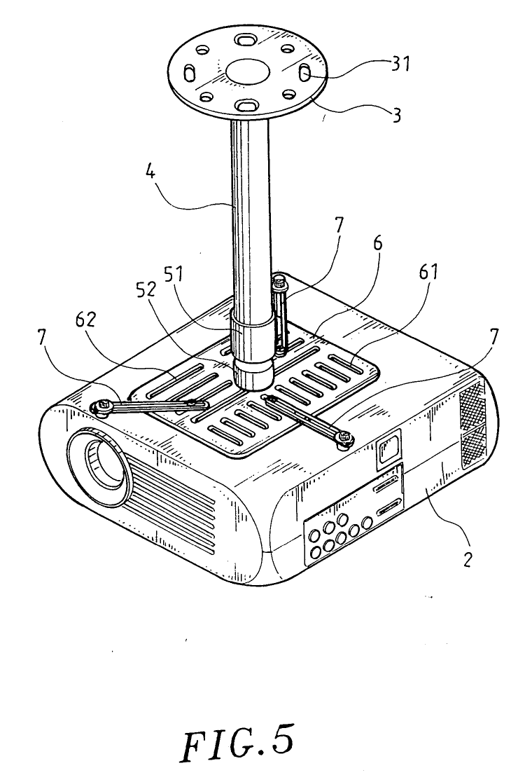

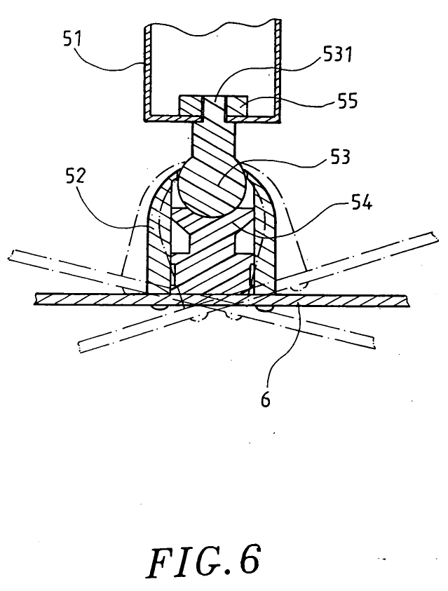

Referring to FIGS. 5 and 6 for the application of the present invention, the fixing hole 31 of the fixed disc 3 is fixed onto the ceiling, and an overhead projector 2 (or other object) is secured on the base 6, such that the overhead projector 2 constitutes a suspending status. After the overhead projector 2 is suspended, the base 6 can be turned to any angle, and the angle of the base 6 can be adjusted by rotating the sphere 53 of the adjusting mechanism 5 along the tray 54, so as to adjust the angle of the overhead projector 2.

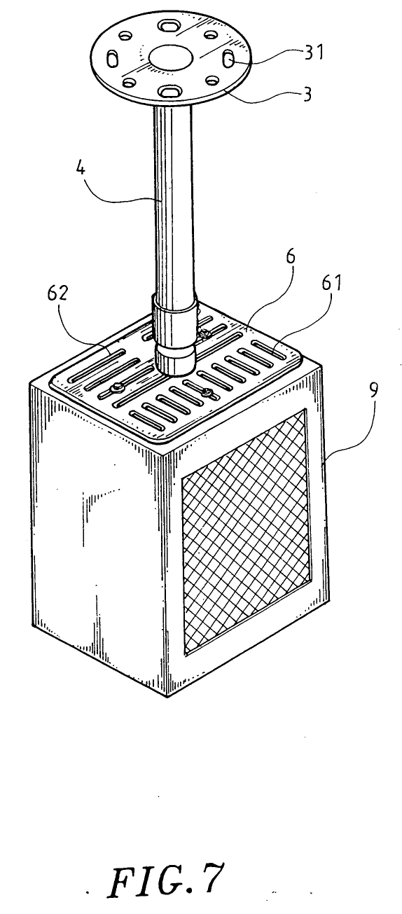

Referring to FIG. 7, the present invention is provided for installing objects such as a speaker fixed on the base 6 or a speaker suspended from the ceiling, and the angle of these objects can be adjusted similarly.

In summation of the above description, the present invention herein complies with the patent application requirements and is submitted for patent application. However, the description and its accompanied drawings are used for describing preferred embodiments of the present invention, and it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. An adjustable suspended shelf structure, comprising:
a fixed disc, having a plurality of fixing holes and a bushing disposed at the center of said fixed disc;
a suspending rod, being a cylindrical rod;
an adjusting mechanism, having a bushing, a fixed base coupled to the bottom of said bushing, a sphere placed into said fixed base and a bowl-shape tray; and
a base, coupled to said adjusting mechanism and having a plurality of longitudinal and transversal long holes disposed with an appropriate distance apart;
thereby, said suspending rod is coupled to said fixed disc and said bushing of said adjusting mechanism, and said fixed disc is fixed onto the ceiling and various different objects are fixed onto said base to constitute a suspending status, and the angle of said suspended shelf is adjusted by rotating said sphere of said adjusting mechanism along said tray.

2. The adjustable suspended shelf structure of claim 1, wherein said adjusting mechanism includes a through hole disposed at the bottom of said bushing, and a penetrating hole disposed at the top of said fixed base, and said sphere has a screw bolt disposed thereon, such that said screw bolt of said sphere is passed through said penetrating hole of said fixed base and said through hole of said bushing and secured by a screw nut.

3. The adjustable suspended shelf structure of claim 1, wherein said adjusting mechanism includes a tray disposed under said sphere and secured by a screw separately on both sides of the fixed base, such that said sphere can be rotated along said tray.
